(19) United States
(12) Patent Application Publication
(10) Pub. No.: US 2024/0056847 A1
(43) Pub. Date: Feb. 15, 2024

(54) REFERENCE SIGNAL REPORTING CONFIGURATION

(71) Applicant: Lenovo (Singapore) Pte. Ltd., New Tech Park (SG)

(72) Inventors: Sher Ali Cheema, Ilmenau (DE); Ankit Bhamri, Rödermark (DE); Ali Ramadan Ali, Kraiburg am Inn (DE); Majid Ghanbarinejad, Chicago, IL (US); Vijay Nangia, Woodridge, IL (US)

(21) Appl. No.: 18/255,997

(22) PCT Filed: Dec. 4, 2021
(86) PCT No.: PCT/IB2021/061341

§ 371 Date: Jun. 5, 2023

Related U.S. Application Data
(60) Provisional application No. 63/121,475, filed on Dec. 4, 2020.

(51) Int. Cl. H04W 24/08; H04L 5/00; H04B 17/24

(52) U.S. Cl. CPC H04W 24/08; H04L 5/0048; H04B 17/24

(57) ABSTRACT

Apparatuses, methods, and systems are disclosed for reference signal reporting configuration. One method includes receiving a configuration from a network device for a plurality of reference signals. The configuration for each reference signal of the plurality of reference signals includes a time-frequency resource, a time-domain behavior, a quasi-co-location assumption, a polarization type, and a usage type corresponding to a reference signal transmission, a reference signal reception, or a combination thereof. The method includes receiving a reporting configuration from the network device. The reporting configuration corresponds to the plurality of reference signals, and the reporting configuration includes the time-frequency resource, the time-domain behavior, and reporting quantities including polarization measurements for each reference signal of the plurality of reference signals.

### CROSS-REFERENCE TO RELATED APPLICATIONS

This application claims priority to U.S. Patent Application Ser. No. 63/121,475 entitled “APPARATUSES, METHODS, AND SYSTEMS FOR REFERENCE SIGNAL BASED POLARIZATION MEASUREMENTS AND REPORTING” and filed on Dec. 4, 2020 for Sher Ali Cheema, which is incorporated herein by reference in its entirety.

### FIELD

The subject matter disclosed herein relates generally to wireless communications and more particularly relates to reference signal reporting configuration.

### BACKGROUND

In certain wireless communications networks, circular polarization may be used. However, circular polarization may add signaling overhead.

### BRIEF SUMMARY

Methods for reference signal reporting configuration are disclosed. Apparatuses and systems also perform the functions of the methods. One embodiment of a method includes receiving, at a user equipment, a configuration from a network device for a plurality of reference signals. The configuration for each reference signal of the plurality of reference signals includes a time-frequency resource, a time-domain behavior, a quasi-co-location assumption, a polarization type, and a usage type corresponding to a reference signal transmission, a reference signal reception, or a combination thereof. In some embodiments, the method includes receiving a reporting configuration from the network device. The reporting configuration corresponds to the plurality of reference signals, and the reporting configuration includes the time-frequency resource, the time-domain behavior, and reporting quantities including polarization measurements for each reference signal of the plurality of reference signals.

One apparatus for reference signal reporting configuration includes a user equipment. In some embodiments, the apparatus includes a receiver that: receives a configuration from a network device for a plurality of reference signals, wherein the configuration for each reference signal of the plurality of reference signals includes a time-frequency resource, a time-domain behavior, a quasi-co-location assumption, a polarization type, and a usage type corresponding to a reference signal transmission, a reference signal reception, or a combination thereof, and receives a reporting configuration from the network device. The reporting configuration corresponds to the plurality of reference signals, and the reporting configuration includes the time-frequency resource, the time-domain behavior, and reporting quantities including polarization measurements for each reference signal of the plurality of reference signals.

Another embodiment of a method for reference signal reporting configuration includes transmitting, from a network device, a configuration to a user equipment for a plurality of reference signals. The configuration for each reference signal of the plurality of reference signals includes a time-frequency resource, a time-domain behavior, a quasi-co-location assumption, a polarization type, and a usage type corresponding to a reference signal transmission, a reference signal reception, or a combination thereof. In some embodiments, the method includes transmitting a reporting configuration to the user equipment. The reporting configuration corresponds to the plurality of reference signals, and the reporting configuration includes the time-frequency resource, the time-domain behavior, and reporting quantities including polarization measurements for each reference signal of the plurality of reference signals.

Another apparatus for reference signal reporting configuration includes a network device. In some embodiments, the apparatus includes a transmitter that: transmits a configuration to a user equipment for a plurality of reference signals, wherein the configuration for each reference signal of the plurality of reference signals includes a time-frequency resource, a time-domain behavior, a quasi-co-location assumption, a polarization type, and a usage type corresponding to a reference signal transmission, a reference signal reception, or a combination thereof; and transmits a reporting configuration to the user equipment. The reporting configuration corresponds to the plurality of reference signals, and the reporting configuration includes the time-frequency resource, the time-domain behavior, and reporting quantities including polarization measurements for each reference signal of the plurality of reference signals.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for reference signal reporting configuration;

FIG. 2 is a schematic block diagram illustrating one embodiment of an apparatus that may be used for reference signal reporting configuration;

FIG. 3 is a schematic block diagram illustrating one embodiment of an apparatus that may be used for reference signal reporting configuration;

FIG. 4 is a schematic block diagram illustrating one embodiment of an NZP-CSI-RS-Resource IE;

FIG. 5 is a schematic block diagram illustrating one embodiment of a system for allocation of an SSB and/or SIB and CSI-RS using multiple BWPs and circular polarization;

FIG. 6 is a schematic block diagram illustrating one embodiment of a system for beam switching within BWPs and for different BWPs;

FIG. 7 is a schematic block diagram illustrating one embodiment of a system for location based BWP;

FIG. 8 is a flow chart diagram illustrating one embodiment of a method for reference signal reporting configuration; and

FIG. 9 is a flow chart diagram illustrating another embodiment of a method for reference signal reporting configuration.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

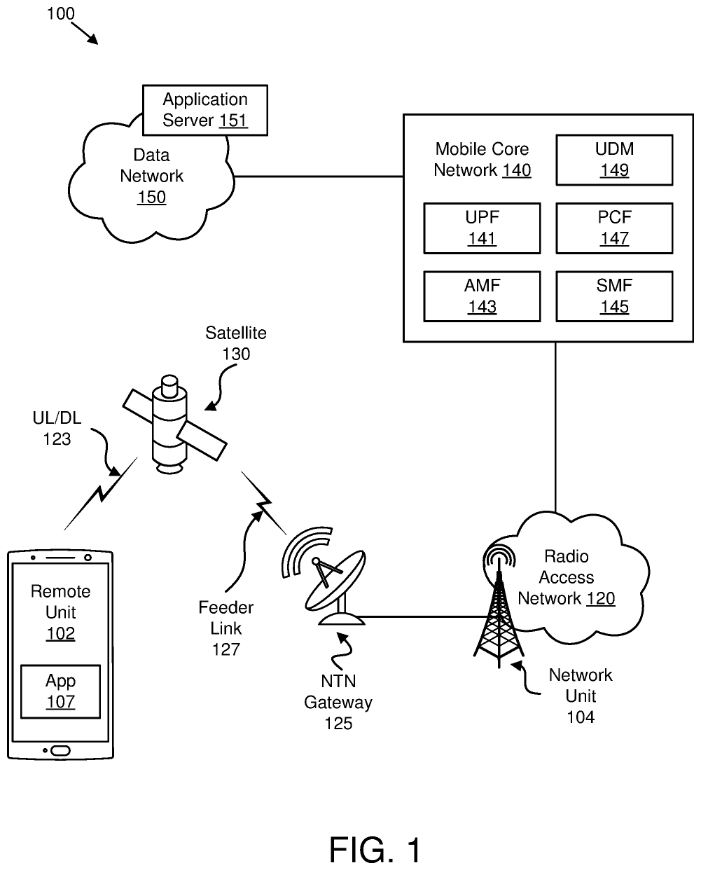

FIG. 1 depicts an embodiment of a wireless communication system 100 for reference signal reporting configuration. In one embodiment, the wireless communication system 100 includes at least one remote unit 102, a radio access network (“RAN”) 120, and a mobile core network 140. The RAN 120 and the mobile core network 140 form a mobile communication network. The RAN 120 may be composed of a network unit 104 with which the remote unit 102 communicates via a satellite 130 using wireless communication links 123. As depicted, the mobile communication network includes an “on-ground” network unit 104 which serves the remote unit 102 via satellite access.

Even though a specific number of remote units 102, network units 104, wireless communication links 123, RANs 120, satellites 130, non-terrestrial network gateways 125 (e.g., satellite ground/earth devices), and mobile core networks 140 are depicted in FIG. 1, one of skill in the art will recognize that any number of remote units 102, network units 104, wireless communication links 123, RANs 120, satellites 130, non-terrestrial network gateways 125, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 102 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 102 include wearable devices, such as smart watches, fitness bands, optical head-mounted displays, or the like. Moreover, the remote units 102 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 102 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 102 may include a terminal equipment (“TE”) and/or be embedded in an appliance or device (e.g., a computing device, as described above).

The remote units 102 may communicate directly with one or more of the network units 104 in the RAN 120 via uplink (“UL”) and downlink (“DL”) communication signals. In some embodiments, the remote units 102 communicate in a non-terrestrial network via UL and DL communication signals between the remote unit 102 and a satellite 130. In certain embodiments, the satellite 130 may communicate with the RAN 120 via an NTN gateway 125 using UL and DL communication signals between the satellite 130 and the NTN gateway 125. The NTN gateway 125 may communicate directly with the network units 104 in the RAN 120 via UL and DL communication signals. Furthermore, the UL and DL communication signals may be carried over the wireless communication links 123. Here, the RAN 120 is an intermediate network that provides the remote units 102 with access to the mobile core network 140. Moreover, the satellite 130 provides a non-terrestrial network allowing the remote unit 102 to access the mobile core network 140 via satellite access. While FIG. 1 depicts a transparent NTN system where the satellite 130 repeats the waveform signal for the network unit 104, in other embodiments the satellite 130 (for regenerative NTN system), or the NTN gateway 125 (for alternative implementation of transparent NTN system) may also act as base station, depending on the deployed configuration.

In some embodiments, the remote units 102 communicate with an application server 151 via a network connection with the mobile core network 140. For example, an application 107 (e.g., web browser, media client, telephone and/or Voice-over-Internet-Protocol (“VoIP”) application) in a remote unit 102 may trigger the remote unit 102 to establish a protocol data unit (“PDU”) session (or other data connection) with the mobile core network 140 via the RAN 120. The mobile core network 140 then relays traffic between the remote unit 102 and the application server 151 in the packet data network 150 using the PDU session. The PDU session represents a logical connection between the remote unit 102 and the User Plane Function (“UPF”) 141.

In order to establish the PDU session (or PDN connection), the remote unit 102 must be registered with the mobile core network 140 (also referred to as “attached to the mobile core network” in the context of a Fourth Generation (“4G”) system). Note that the remote unit 102 may establish one or more PDU sessions (or other data connections) with the mobile core network 140. As such, the remote unit 102 may have at least one PDU session for communicating with the packet data network 150. The remote unit 102 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 102 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 102 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The network units 104 may be distributed over a geographic region. In certain embodiments, a network unit 104 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The network units 104 are generally part of a RAN, such as the RAN 120, that may include one or more controllers communicably coupled to one or more corresponding network units 104. These and other elements of radio access network are not illustrated but are well known generally by those having ordinary skill in the art. The network units 104 connect to the mobile core network 140 via the RAN 120. Note that in the NTN scenario certain RAN entities or functions may be incorporated into the satellite 130. For example, the satellite 130 may be an embodiment of a Non-Terrestrial base station/base unit.

The network units 104 may serve a number of remote units 102 within a serving area, for example, a cell or a cell sector, via a wireless communication link 123. The network units 104 may communicate directly with one or more of the remote units 102 via communication signals. Generally, the network units 104 transmit DL communication signals to serve the remote units 102 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 102 and/or one or more of the network units 104. Note that during NR operation on unlicensed spectrum (referred to as “NR-U”), the network unit 104 and the remote unit 102 communicate over unlicensed (i.e., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 102 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”, also referred to as “Unified Data Repository”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the Fifth Generation Core network (“5GC”). When present, the AUSF may act as an authentication server and/or authentication proxy, thereby allowing the AMF 143 to authenticate a remote unit 102. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 102 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for dynamically adapting a measurement behavior apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for dynamically adapting a measurement behavior.

In various embodiments, a remote unit 102 may receive a configuration from a network device for a plurality of reference signals. The configuration for each reference signal of the plurality of reference signals includes a time-frequency resource, a time-domain behavior, a quasi-co-location assumption, a polarization type, and a usage type corresponding to a reference signal transmission, a reference signal reception, or a combination thereof. In some embodiments, the remote unit 102 may receive a reporting configuration from the network device. The reporting configuration corresponds to the plurality of reference signals, and the reporting configuration includes the time-frequency resource, the time-domain behavior, and reporting quantities including polarization measurements for each reference signal of the plurality of reference signals. Accordingly, the remote unit 102 may be used for reference signal reporting configuration.

In certain embodiments, a network unit 104 and/or mobile core network 140 may transmit a configuration to a user equipment for a plurality of reference signals. The configuration for each reference signal of the plurality of reference signals includes a time-frequency resource, a time-domain behavior, a quasi-co-location assumption, a polarization type, and a usage type corresponding to a reference signal transmission, a reference signal reception, or a combination thereof. In some embodiments, the network unit 104 and/or mobile core network 140 may transmit a reporting configuration to the user equipment. The reporting configuration corresponds to the plurality of reference signals, and the reporting configuration includes the time-frequency resource, the time-domain behavior, and reporting quantities including polarization measurements for each reference signal of the plurality of reference signals. Accordingly, the network unit 104 may be used for reference signal reporting configuration.

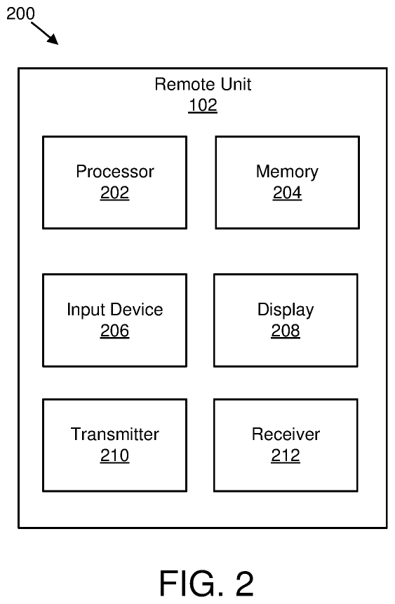

FIG. 2 depicts one embodiment of an apparatus 200 that may be used for reference signal reporting configuration. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In various embodiments, the receiver 212: receives a configuration from a network device for a plurality of reference signals, wherein the configuration for each reference signal of the plurality of reference signals includes a time-frequency resource, a time-domain behavior, a quasi-co-location assumption, a polarization type, and a usage type corresponding to a reference signal transmission, a reference signal reception, or a combination thereof, and receives a reporting configuration from the network device. The reporting configuration corresponds to the plurality of reference signals, and the reporting configuration includes the time-frequency resource, the time-domain behavior, and reporting quantities including polarization measurements for each reference signal of the plurality of reference signals.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

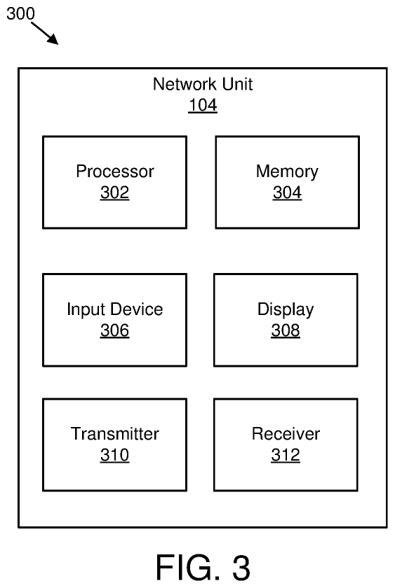

FIG. 3 depicts one embodiment of an apparatus 300 that may be used for reference signal reporting configuration. The apparatus 300 includes one embodiment of the network unit 104 and/or one or more functions of the mobile core network 140. Furthermore, the network unit 104 and/or one or more functions of the mobile core network 140 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310: transmits a configuration to a user equipment for a plurality of reference signals, wherein the configuration for each reference signal of the plurality of reference signals includes a time-frequency resource, a time-domain behavior, a quasi-co-location assumption, a polarization type, and a usage type corresponding to a reference signal transmission, a reference signal reception, or a combination thereof, and transmits a reporting configuration to the user equipment. The reporting configuration corresponds to the plurality of reference signals, and the reporting configuration includes the time-frequency resource, the time-domain behavior, and reporting quantities including polarization measurements for each reference signal of the plurality of reference signals.

In certain embodiments, features may be enhanced to address issues due to long propagation delays, large Doppler effects, and moving cells in a non-terrestrial network (“NTN”), such as the following: 1) timing relationship enhancements; 2) enhancements on uplink (“UL”) time and frequency synchronization; and/or 3) hybrid automatic repeat request (“HARQ”), a) number of HARQ process, b) enabling and/or disabling of HARQ feedback.

In some embodiments, there may be: 1) enhancement to a physical random access channel (“PRACH”) sequence and/or format and extension of a ra-ResponseWindow duration (e.g., if a user equipment (“UE”) with global navigation satellite system (“GNSS”) capability but without pre-compensation of timing and frequency offset capabilities); 2) feeder link switch; and/or 3) beam management and bandwidth part (“BWP”) operation for NTN with frequency reuse such as by including signaling of a polarization mode.

In various embodiments, circular polarization may be widely used in satellite communications due to its advantages such as inter cell interference mitigation, higher spectral efficiency, spectrum sharing, and robustness against atmospheric losses.

In certain embodiments, there may be cell deployment with a frequency reuse factor of 3 and 4. In such embodiments, there may be one-to-one and/or one-to-many mapping between BWPs, beams, and polarizations, where single or multiple polarizations are supported within a beam or BWP. Accordingly, polarization-based measurement and reporting may be required for efficient beam or BWP switching. On the other hand, polarization-based measurement and reporting procedures may add additional signaling overhead. Therefore, measurement and reporting configuration enhancements may be made to avoid large signaling overhead.

In some embodiments, there may be reference signal (“RS”) based measurements for different polarizations and enhancements to corresponding reporting for one or multiple beams.

In various embodiments, RSs, such as a channel state information (“CSI”) RS (“CSI-RS”), may be configured to be associated with one or more specific polarization types (e.g., along with other parameters such as quasi-co-location (“QCL”) assumption, code division multiplexing (“CDM”) type, time-frequency resources, time-domain behavior, etc.) to perform corresponding measurements at a UE. Furthermore, enhancements to reporting configurations may be made to indicate polarization-based measurement quantities from a UE to a gNB.

In a first embodiment, there may be RS configurations for polarization measurements. In the first embodiment, CSI resources are configured in a way that each CSI resource identifier (“ID”) is associated with a polarization type. For example, a first CSI-RS ID (“CSI-RS ID1”) may be associated with a time and frequency resource 1, a beam 1 (e.g., QCL-TypeD QCL source RS), and/or a polarization type 1.

In one implementation of the first embodiment, CSI-RS may be scrambled with other sequences, where each sequence represents a polarization type, to distinguish between different polarization RS. In another implementation of the first embodiment, the pseudo-random sequence generator initialization for the CSI-RS sequence may be based on the polarization type. In one example, two CSI-RS antenna ports (e.g., on different CDM groups) in the CSI-RS resource may be associated with different polarization types.

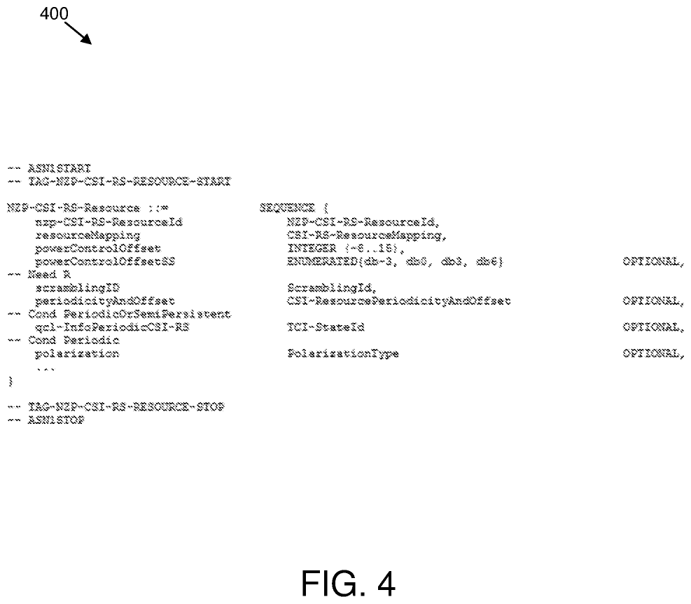

An illustration of an enhanced CSI-RS configuration association with a polarization type is shown in FIG. 4 for periodic CSI-RS. Specifically, FIG. 4 is a schematic block diagram illustrating one embodiment of a non-zero-power (“NZP”) CSI-RS resource (“NZP-CSI-RS-Resource”) information element (“IE”) 400.

In FIG. 4, the polarization type may be determined explicitly, for example as ENUMERATED {RHCP, LHCP, linear}, or in association with a default and/or implicitly linked polarization type such as a polarization obtained during initial access. In certain embodiments, a default polarization may be used if an optional field is not explicitly configured.

FIG. 4 is just an example for periodic CSI-RS; however, such a configuration of CSI-RS that provides a polarization type may be applicable for aperiodic CSI-RS (e.g., and semi-persistent CSI-RS as well (e.g., indicated in the qcl-info list of references to TCI-States (e.g., in the TCI-state configuration) for providing the QCL source and QCL type for each NZP-CSI-RS-Resource within the aperiodic and/or semi persistent NZP CSI-RS resource set, or indicated as a polarization-info list for providing the polarization type for each NZP CSI-RS Resource within the aperiodic and/or semi persistent NZP CSI-RS resource set (in addition to the QCL-info list))).

In some embodiments, a new RS type may be configured for polarization-based measurements that may be periodic, aperiodic, and/or semi-persistent.

In various embodiments, a new QCL type (e.g., QCL Type-E) may be used to indicate an association between a source (e.g., reference) RS and a target RS in terms of polarization type. If the TCI state (e.g., qcl-InfoPeriodicCSI-RS in FIG. 4 for periodic CSI-RS) indicates this new QCL Type-E, then the target CSI-RS may be expected to be transmitted and/or received using the same polarization type as applied for the source RS. In certain embodiments, a definition of an existing QCL type, such as QCL Type-D, may be extended to include an association between circular polarizations (e.g., QCL-TypeD-LC to indicate left-hand circular polarization (“LHCP”), QCL-TypeD-RC to indicate right-hand circular polarization (“RHCP”)). In some embodiments, a polarization type parameter may be indicated in quasi collocation information (e.g., QCL-Info) provided in a transmission configuration indicator (“TCI”) state for a source (e.g., reference) RS.

In some embodiments, a UE uses a configured polarization type to receive a CSI-RS with a CSI-RS resource to perform polarization and/or CSI measurements.

In a second embodiment, there may be an indication of polarization-based measurements in a CSI-report. In the second embodiment, CSI reporting may be enhanced to indicate a polarization type (e.g., LHCP, RHCP, or linear) transmitted from a UE to a network (e.g., gNB) based on polarization-based channel measurements (on the CSI-RS). For example, a UE may be configured with CSI-ReportConfig with a higher layer parameter reportQuantity set to a value such as ‘cri-RI-PMI-CQI-POLi’, ‘cri-RI-CQI-POLi’, ‘cri-RI-LI-PMI-CQI-POLi’ or ‘POLi’, where the polarization index (“POLi”) is used as an example to indicate a polarization in quantities to be reported by the UE. In various embodiments, a polarization may be reported by a separate field in a report, such as reportPolQuantity, where inclusion of this field may be determined by a CSI-ReportConfig or lower layer signaling. Based on the measurements, the UE indicates at least one index corresponding to a single or multiple polarization types.

TABLE 1
An example of multiple polarization indication in CSI report

| Index | Polarization |
|---|---|
| 0 | LHCP |
| 1 | RHCP |
| 2 | Horizontal |
| 3 | Vertical |
| 4 | LHCP and RHCP |
| 5 | Vertical and horizontal |
| 6 | Vertical, horizontal, and LHCP |

In certain embodiments, a UE may be configured with CSI-ReportConfig with a higher layer parameter reportQuantity or reportPolQuantity set to indicate only one of a circular or a linear polarization type. This may reduce a number of bits to report a polarization type (e.g., requires only bit ‘0’ or ‘1’ to indicate either circular polarization type (e.g., LHCP or RHCP) or linear polarization type (e.g., vertical, horizontal). In some embodiments, a set of polarization types may be determined for a UE by configuration or signaling, and then a field value may be an index to the set. Such an embodiment may be useful where only one type of polarization is used in a cell (e.g., circular polarization with frequency reuse factor (“FRF”)=4). In various embodiments described herein, a large amount of overhead may be saved if a limited number of polarization combinations are associated with reference signals on which a UE is to perform measurements and produce a report.

In a third embodiment, there may be gNB dominant measuring and reporting procedures. In the third embodiment, a UE performs RS measurements on different bandwidth parts (“BWPs”), polarization with BWP, and polarization switching. For instance, a satellite transponder may transmit a synchronization signal block (“SSB”) and/or system information block (“SIB”) on all beams within a cell on a first BWP (“BWP #0”). After a radio resource control (“RRC”) connection, a gNB may configure another BWP and a polarization with a transmission to a UE. Then, the UE may measure a CSI-RS on an activate BWP and indicated polarization. After that, the gNB indicates to the UE through downlink configuration (“DCI”) or medium access control (“MAC”) signaling to perform measurements on different polarizations on the active BWP. Similarly, measurements on the other BWPs and polarizations may be triggered by the gNB via DCI indication or the MAC signaling. The UE may associate a periodic, aperiodic, or semi-persistent CSI report with each of the polarization-based CSI resources in a BWP. However, such procedure may result in large delays because of large measurement and reporting overheads.

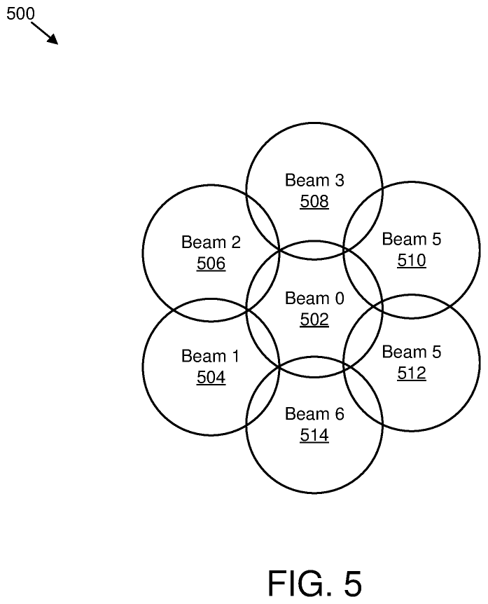

FIG. 5 is a schematic block diagram illustrating one embodiment of a system 500 for allocation of an SSB and/or SIB and CSI-RS using multiple BWPs and circular polarization. Specifically, the system 500 includes a beam 0 502, a beam 1 504, a beam 2 506, a beam 3 508, a beam 4 510, a beam 5 512, and a beam 6 514. Moreover, the beam 0 502 corresponds to F2 and LHCP, the beam 1 504 corresponds to F2 and RHCP, the beam 2 506 corresponds to F1 and RHCP, the beam 3 508 corresponds to F1 and LHCP, the beam 4 510 corresponds to F2 and RHCP, the beam 5 512 corresponds to F1 and LHCP, and the beam 6 514 corresponds to F1 and RHCP. Further, a first BWP (BWP #0) may be used to carry SSB using a plurality of beams, a second BWP (BWP #2) may be used to carry CSI-RS on LHCP and/or RHCP resources, and a third BWP (BWP #3) may be used to carry CSI-RS on LHCP and/or RHCP resources.

In certain embodiments, a gNB may indicate to a UE via DCI or MAC signaling to do measurements of different polarizations simultaneously on an active BWP. To reduce uplink (“UL”) signaling overhead, the UE may associate a single CSI report with two or more CSI-RS resources (e.g., LHCP CSI-RS and RHCP CSI-RS) in a BWP. The CSI-RS resource (from the two or more CSI-RS resources) corresponding to or a portion of the CSI-RS report may be distinguished and/or indicated by a field in the report that determines the polarization used for performing the measurements.

In some embodiments, uplink control information (“UCI”) and/or a physical uplink control channel (“PUCCH”) resource configured for a periodic CSI report may be used for transmitting measurements by two or more polarizations. In such embodiments, a polarization field may be included in each CSI report.

In various embodiments, a gNB periodically determines a UE position either through positioning methods (e.g., RAT-dependent, UE-based and/or UE-assisted positioning techniques (e.g., downlink (“DL”) time-difference-of-arrival (“TDOA”) (“DL-TDOA”), round trip time (“RTT”), DL angle of departure (“AoD”) (“DL-AoD”), UL angle of arrival (“AoA”) (“UL-AoA”))) or configures a global navigation satellite system (“GNSS”) capable UE to indicate its position in a periodic or aperiodic manner. Based on the knowledge of the location of UE, the gNB triggers a measurement and reporting procedure for only polarization switching in an active BWP or also an inactive BWP.

In certain embodiments, a beam may be associated with a particular polarization type. A UE may implicitly assume all communication using that beam uses the associated polarization type, unless otherwise indicated.

In a fourth embodiment, there may be UE assisted measurement and reporting based on signal coverage. In the fourth embodiment, the UE dynamically may adjust its measurement and reporting periodicity based on a signal strength. In one implementation, a gNB configures a mapping table for BWP-wise CSI measurements, where the UE adapts its CSI measurements and reporting periodicity for different polarizations in an active BWP. For example, the UE performs measurement with a first reporting periodicity for computing an layer 1 (“L1”) reference signal received power (“RSRP”) (“L1-RSRP”) value by applying LHCP, and then if this value is above a certain threshold (e.g., first threshold), the UE increases the reporting periodicity (or generally uses a second reporting periodicity) and only indicates the current polarization in the CSI report. The UE continues to execute this procedure, and as soon as the value falls below a certain threshold (e.g., a second threshold e.g., including hysteresis), the UE starts measuring on both polarizations and reduces the measurement periodicity (e.g., a third reporting periodicity or back to the first reporting periodicity). Then the UE indicates two measurements in a CSI report corresponding to two CSI resources in an active BWP. If an L1-RSRP threshold value with other polarization increases (e.g., L1-RSRP RHCP>L1-RSRP LHCP), this indicates to the UE and the gNB about the direction of travel of the UE and/or a satellite (e.g., can use the same BWP, with polarization switching and potential beam switch). In certain embodiments, only beam and polarization switching are required in the same active BWP. This may not only reduce signaling overhead but also may avoid BWP switching. Such embodiments may be more frequent for low earth orbit (“LEO”) satellites systems with earth moving beams where frequent beam switching based on only polarization is needed.

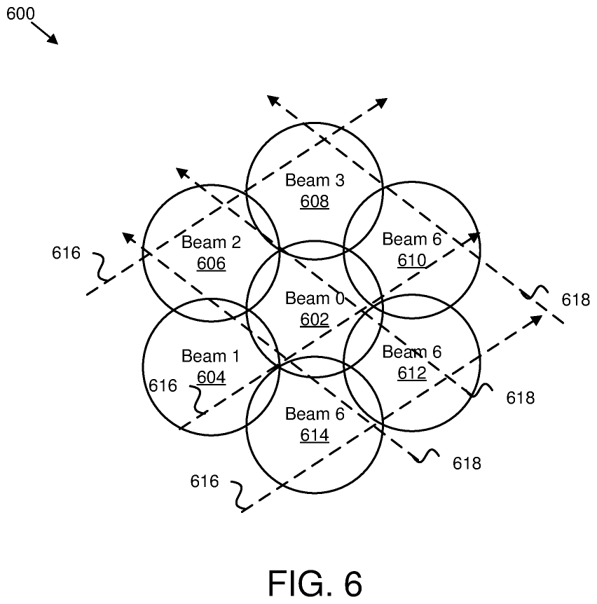

FIG. 6 is a schematic block diagram illustrating one embodiment of a system 600 for beam switching within BWPs and for different BWPs. Specifically, the system 600 includes a beam 0 602, a beam 1604, a beam 2 606, a beam 3 608, a beam 4 610, a beam 5 612, and a beam 6 614. Moreover, the beam 0 602 corresponds to F0 and LHCP on a second BWP (BWP2), the beam 1 604 corresponds to F0 and RHCP on BWP2, the beam 2 606 corresponds to F1 and RHCP on a first BWP (BWP1), the beam 3 608 corresponds to F1 and LHCP on BWP1, the beam 4 610 corresponds to F0 and RHCP on BWP2, the beam 5 612 corresponds to F1 and RHCP on BWP1, and the beam 6 614 corresponds to F1 and LHCP on BWP1. Arrows 616 show UE mobility with a BWP, and arrows 618 show UE mobility within different BWPs.

In some embodiments, details of a procedure and/or values, such as a threshold, may be determined by a configuration, a field in a reporting configuration, a pre-configuration, a specification, or the like.

In various embodiments, a UE measures an L1-RSRP level on inactive BWPs if a threshold for both polarization measurements in an active BWP falls below a predefined threshold (e.g., by a mapping table). In such embodiments, the UE may require BWP switching in addition to polarization switching.

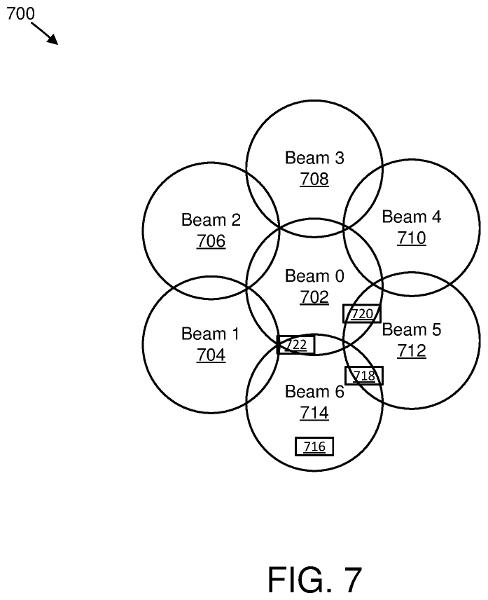

In a fifth embodiment, there may be UE assisted measurement and reporting based on a location. According to the fifth embodiment, the UE dynamically sets its CSI measurement and reporting periodicity based on its location in a beam. The location may be obtained via a GNSS (e.g., radio access technology (“RAT”) independent positioning techniques) for UEs equipped with it or with other positioning methods (e.g., RAT-dependent, UE-based and/or UE-assisted positioning techniques (e.g., DL-TDOA, RTT, DL-AoD, UL-AoA)). A location-based mapping table may describe measurement and reporting periodicity for different locations with BWP and polarization indications may be preconfigured based on NTN beam deployment scenarios. An example table for measurement and reporting periodicity for UEs in FIG. 7 is shown in Table 2.

FIG. 7 is a schematic block diagram illustrating one embodiment of a system 700 for location based BWP with polarization and/or beam measurement. Specifically, the system 700 includes a beam 0 702, a beam 1 704, a beam 2 706, a beam 3 708, a beam 4 710, a beam 5 712, and a beam 6 714. Moreover, the beam 0 702 corresponds to F0 and LHCP, the beam 1 704 corresponds to F0 and RHCP, the beam 2 706 corresponds to F1 and RHCP, the beam 3 708 corresponds to F1 and LHCP, the beam 4 710 corresponds to F0 and RHCP, the beam 5 712 corresponds to F1 and RHCP, and the beam 6 714 corresponds to F1 and LHCP. F1 corresponds to a first BWP (BWP1), F0 corresponds to a second BWP (BWP2). Multiple UEs 716, 718, 720, and 722 are illustrated. Specifically, there is a first UE 716 (UE1), a second UE 718 (UE2), a third UE 720 (UE3), and a fourth UE 722 (UE4). Each UEn is in a location n. Areas that overlap among F0 devices are areas with the same frequency, areas that overlap with F1 devices are areas with the same frequency, and areas that overlap with F1 and F0 devices do not have the same frequency.

TABLE 2
Example of location-based mapping table
for measurement and reporting periodicity

| | Measurement | Reporting | |
|---|---|---|---|
| Locations | periodicity | periodicity | Measurement parameters |
| Location 1 | 25 ms | 50 ms | BWP 1(active) with LHCP |
| Location 2 | 15 ms | 10 ms | BWP 1 (active) with LHCP, |
| | | | RHCP |
| Location 3 | 10 ms | 5 ms | BWP 1 (active) with RHCP, |
| | | | BWP 2 (inactive) with LHCP |
| Location 4 | 5 ms | 5 ms | BWP 1 (active) with LHCP, |
| | | | BWP 2 (inactive) with LHCP |
| | | | and RHCP |

Each of the polarization types associated with BWPs may be determined explicitly by a field or set to a default value if the field does not exist. The default value may be obtained during initial access, determined by a configuration, or the like.

In a sixth embodiment, there may be a polarization measurement for UL. According to the sixth embodiment, a UE is configured with UL resources to transmit multiple sounding reference signals (“SRSs”) each with different polarization. The gNB performs SRS measurement on corresponding resources and identifies successfully received SRS based on a predefined threshold. The number and/or the types of correctly received polarization and/or an indication of the polarization type may be signaled to the UE in DCI (e.g., along with the multiplexing or diversity scheme to be used for the next and/or corresponding UL transmissions).

In one implementation, the UE is configured with resources to transmit multiple SRS with different polarization types (e.g., two or more SRS with different polarization types may be configured as part of the same SRS resource, or SRSs in a SRS resource may have the same polarization type). Upon detecting the multiple SRS (e.g., determining the SRS quality and/or RSRP (e.g., with a predefined threshold)), the gNB indicates to the UE (e.g., via an SRS resource indicator (“SRI”) field in DCI) the polarization type and/or the diversity or multiplexing scheme for UL transmission.

In another implementation for UL transmission (e.g., PUCCH, SRS, UL positioning RS, physical uplink shared channel (“PUSCH”)), the spatialRelationInfo configuration which configures the spatial relation between a source (e.g., reference) RS and a target UL signal (e.g., SRS) or channel (e.g., PUCCH) also includes indication of the polarization type of the source RS. The UE may be expected to transmit the UL transmission (e.g., target UL signal or channel) with the same polarization type as that for the indicated source RS.

It should be noted that for methods and embodiments found herein, polarization types such as RHCP, LHCP, linear polarization, and other polarizations in Table 1, are presented as examples. These polarization types may or may not be defined explicitly. In some implementations, a polarization may be indicated explicitly. In various implementations, a polarization may be indicated implicitly by indicating properties associated with the polarization. In certain implementations, a polarization may be defined according to a configuration, a pre-configuration, a standard specification, or a combination thereof, and then referred to in subsequent communications.

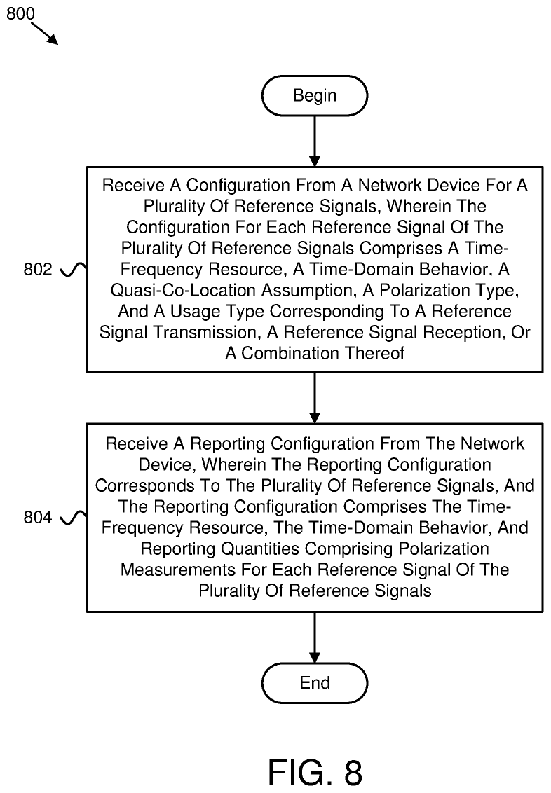

FIG. 8 is a flow chart diagram illustrating one embodiment of a method 800 for reference signal reporting configuration. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802 a configuration from a network device for a plurality of reference signals. The configuration for each reference signal of the plurality of reference signals includes a time-frequency resource, a time-domain behavior, a quasi-co-location assumption, a polarization type, and a usage type corresponding to a reference signal transmission, a reference signal reception, or a combination thereof. In some embodiments, the method 800 includes receiving 804 a reporting configuration from the network device. The reporting configuration corresponds to the plurality of reference signals, and the reporting configuration includes the time-frequency resource, the time-domain behavior, and reporting quantities including polarization measurements for each reference signal of the plurality of reference signals.

In certain embodiments, the plurality of reference signals is configured so that each reference signal of the plurality of reference signals corresponds to a polarization type. In some embodiments, a quasi-co-location type indicates an association between a polarization type corresponding to a source reference signal and a target reference signal. In various embodiments, the method 800 further comprises transmitting a report corresponding to the reporting configuration, wherein the report for each reference signal of the plurality of reference signals indicates a polarization type to the network device based on polarization-based channel measurements.

In one embodiment, the method 800 further comprises transmitting a report corresponding to the reporting configuration, wherein the report indicates one type of circular polarization or linear polarization. In certain embodiments, the method 800 further comprises performing reference signal measurements on different bandwidth parts and polarizations that are configured by the network device to carry out bandwidth part and polarization switching. In some embodiments, the method 800 further comprises receiving downlink control information or medium access control signaling indicating for the user equipment to perform measurements on different polarizations on active bandwidth parts, inactive bandwidth parts, or a combination thereof.

In various embodiments, the method 800 further comprises receiving information that triggers a measurement and reporting procedure for polarization switching in active bandwidth parts, inactive bandwidth parts, or a combination thereof based on a location of the user equipment. In one embodiment, the method 800 further comprises dynamically adjusting a polarization measurement and reporting periodicity based on a signal strength and a mapping table preconfigured by the network device. In certain embodiments, the method 800 further comprises dynamically adjusting a polarization measurement and reporting periodicity based on a location of the user equipment and a mapping table that is preconfigured by the network device.

In some embodiments, the method 800 further comprises configuring uplink resources to transmit multiple sounding reference signals, wherein each sounding reference signal of the multiple sounding reference signal is associated with a polarization type. In various embodiments, the method 800 further comprises configuring uplink resources using spatial relation configuration, wherein this configuration also includes an indication of the polarization type of a source reference signal.

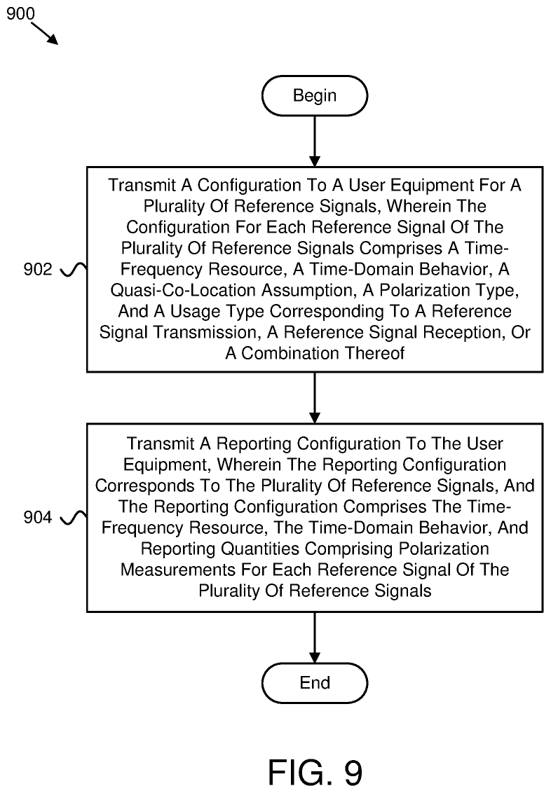

FIG. 9 is a flow chart diagram illustrating another embodiment of a method 900 for reference signal reporting configuration. In some embodiments, the method 900 is performed by an apparatus, such as the network unit 104 and/or one or more functions of the mobile core network 140. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes transmitting 902 a configuration to a user equipment for a plurality of reference signals. The configuration for each reference signal of the plurality of reference signals includes a time-frequency resource, a time-domain behavior, a quasi-co-location assumption, a polarization type, and a usage type corresponding to a reference signal transmission, a reference signal reception, or a combination thereof. In some embodiments, the method 900 includes transmitting 904 a reporting configuration to the user equipment. The reporting configuration corresponds to the plurality of reference signals, and the reporting configuration includes the time-frequency resource, the time-domain behavior, and reporting quantities including polarization measurements for each reference signal of the plurality of reference signals.

In certain embodiments, the plurality of reference signals is configured so that each reference signal of the plurality of reference signals corresponds to a polarization type. In some embodiments, a quasi-co-location type indicates an association between a polarization type corresponding to a source reference signal and a target reference signal. In various embodiments, the method 900 further comprises receiving a report corresponding to the reporting configuration, wherein the report for each reference signal of the plurality of reference signals indicates a polarization type to the network device based on polarization-based channel measurements.

In one embodiment, the method 900 further comprises receiving a report corresponding to the reporting configuration, wherein the report indicates one type of circular polarization or linear polarization. In certain embodiments, the method 900 further comprises transmitting downlink control information or medium access control signaling indicating for the user equipment to perform measurements on different polarizations on active bandwidth parts, inactive bandwidth parts, or a combination thereof. In some embodiments, the method 900 further comprises transmitting information that triggers a measurement and reporting procedure for polarization switching in active bandwidth parts, inactive bandwidth parts, or a combination thereof based on a location of the user equipment.

In one embodiment, a method of a user equipment comprises: receiving a configuration from a network device for a plurality of reference signals, wherein the configuration for each reference signal of the plurality of reference signals comprises a time-frequency resource, a time-domain behavior, a quasi-co-location assumption, a polarization type, and a usage type corresponding to a reference signal transmission, a reference signal reception, or a combination thereof, and receiving a reporting configuration from the network device, wherein the reporting configuration corresponds to the plurality of reference signals, and the reporting configuration comprises the time-frequency resource, the time-domain behavior, and reporting quantities comprising polarization measurements for each reference signal of the plurality of reference signals.

In certain embodiments, the plurality of reference signals is configured so that each reference signal of the plurality of reference signals corresponds to a polarization type.

In some embodiments, a quasi-co-location type indicates an association between a polarization type corresponding to a source reference signal and a target reference signal.

In various embodiments, the method further comprises transmitting a report corresponding to the reporting configuration, wherein the report for each reference signal of the plurality of reference signals indicates a polarization type to the network device based on polarization-based channel measurements.

In one embodiment, the method further comprises transmitting a report corresponding to the reporting configuration, wherein the report indicates one type of circular polarization or linear polarization.

In certain embodiments, the method further comprises performing reference signal measurements on different bandwidth parts and polarizations that are configured by the network device to carry out bandwidth part and polarization switching.

In some embodiments, the method further comprises receiving downlink control information or medium access control signaling indicating for the user equipment to perform measurements on different polarizations on active bandwidth parts, inactive bandwidth parts, or a combination thereof.

In various embodiments, the method further comprises receiving information that triggers a measurement and reporting procedure for polarization switching in active bandwidth parts, inactive bandwidth parts, or a combination thereof based on a location of the user equipment.

In one embodiment, the method further comprises dynamically adjusting a polarization measurement and reporting periodicity based on a signal strength and a mapping table preconfigured by the network device.

In certain embodiments, the method further comprises dynamically adjusting a polarization measurement and reporting periodicity based on a location of the user equipment and a mapping table that is preconfigured by the network device.

In some embodiments, the method further comprises configuring uplink resources to transmit multiple sounding reference signals, wherein each sounding reference signal of the multiple sounding reference signal is associated with a polarization type.

In various embodiments, the method further comprises configuring uplink resources using spatial relation configuration, wherein this configuration also includes an indication of the polarization type of a source reference signal.

In one embodiment, an apparatus comprises a user equipment. The apparatus further comprises: a receiver that: receives a configuration from a network device for a plurality of reference signals, wherein the configuration for each reference signal of the plurality of reference signals comprises a time-frequency resource, a time-domain behavior, a quasi-co-location assumption, a polarization type, and a usage type corresponding to a reference signal transmission, a reference signal reception, or a combination thereof, and receives a reporting configuration from the network device, wherein the reporting configuration corresponds to the plurality of reference signals, and the reporting configuration comprises the time-frequency resource, the time-domain behavior, and reporting quantities comprising polarization measurements for each reference signal of the plurality of reference signals.

In certain embodiments, the plurality of reference signals is configured so that each reference signal of the plurality of reference signals corresponds to a polarization type.

In some embodiments, a quasi-co-location type indicates an association between a polarization type corresponding to a source reference signal and a target reference signal.

In various embodiments, the apparatus further comprises a transmitter that transmits a report corresponding to the reporting configuration, wherein the report for each reference signal of the plurality of reference signals indicates a polarization type to the network device based on polarization-based channel measurements.

In one embodiment, the apparatus further comprises a transmitter that transmits a report corresponding to the reporting configuration, wherein the report indicates one type of circular polarization or linear polarization.

In certain embodiments, the apparatus further comprises a processor that performs reference signal measurements on different bandwidth parts and polarizations that are configured by the network device to carry out bandwidth part and polarization switching.

In some embodiments, the receiver receives downlink control information or medium access control signaling indicating for the user equipment to perform measurements on different polarizations on active bandwidth parts, inactive bandwidth parts, or a combination thereof.

In various embodiments, the receiver receives information that triggers a measurement and reporting procedure for polarization switching in active bandwidth parts, inactive bandwidth parts, or a combination thereof based on a location of the user equipment.

In one embodiment, the apparatus further comprises a processor that dynamically adjusts a polarization measurement and reporting periodicity based on a signal strength and a mapping table preconfigured by the network device.

In certain embodiments, the apparatus further comprises a processor that dynamically adjusts a polarization measurement and reporting periodicity based on a location of the user equipment and a mapping table that is preconfigured by the network device.

In some embodiments, the apparatus further comprises a processor that configures uplink resources to transmit multiple sounding reference signals, wherein each sounding reference signal of the multiple sounding reference signal is associated with a polarization type.

In various embodiments, the apparatus further comprises a processor that configures uplink resources using spatial relation configuration, wherein this configuration also includes an indication of the polarization type of a source reference signal.

In one embodiment, a method of a network device comprises: transmitting a configuration to a user equipment for a plurality of reference signals, wherein the configuration for each reference signal of the plurality of reference signals comprises a time-frequency resource, a time-domain behavior, a quasi-co-location assumption, a polarization type, and a usage type corresponding to a reference signal transmission, a reference signal reception, or a combination thereof, and transmitting a reporting configuration to the user equipment, wherein the reporting configuration corresponds to the plurality of reference signals, and the reporting configuration comprises the time-frequency resource, the time-domain behavior, and reporting quantities comprising polarization measurements for each reference signal of the plurality of reference signals.

In certain embodiments, the plurality of reference signals is configured so that each reference signal of the plurality of reference signals corresponds to a polarization type.

In some embodiments, a quasi-co-location type indicates an association between a polarization type corresponding to a source reference signal and a target reference signal.

In various embodiments, the method further comprises receiving a report corresponding to the reporting configuration, wherein the report for each reference signal of the plurality of reference signals indicates a polarization type to the network device based on polarization-based channel measurements.

In one embodiment, the method further comprises receiving a report corresponding to the reporting configuration, wherein the report indicates one type of circular polarization or linear polarization.

In certain embodiments, the method further comprises transmitting downlink control information or medium access control signaling indicating for the user equipment to perform measurements on different polarizations on active bandwidth parts, inactive bandwidth parts, or a combination thereof.

In some embodiments, the method further comprises transmitting information that triggers a measurement and reporting procedure for polarization switching in active bandwidth parts, inactive bandwidth parts, or a combination thereof based on a location of the user equipment.

In one embodiment, an apparatus comprises a network device. The apparatus further comprises: a transmitter that: transmits a configuration to a user equipment for a plurality of reference signals, wherein the configuration for each reference signal of the plurality of reference signals comprises a time-frequency resource, a time-domain behavior, a quasi-co-location assumption, a polarization type, and a usage type corresponding to a reference signal transmission, a reference signal reception, or a combination thereof, and transmits a reporting configuration to the user equipment, wherein the reporting configuration corresponds to the plurality of reference signals, and the reporting configuration comprises the time-frequency resource, the time-domain behavior, and reporting quantities comprising polarization measurements for each reference signal of the plurality of reference signals.

In certain embodiments, the plurality of reference signals is configured so that each reference signal of the plurality of reference signals corresponds to a polarization type.

In some embodiments, a quasi-co-location type indicates an association between a polarization type corresponding to a source reference signal and a target reference signal.

In various embodiments, the apparatus further comprises a receiver that receives a report corresponding to the reporting configuration, wherein the report for each reference signal of the plurality of reference signals indicates a polarization type to the network device based on polarization-based channel measurements.

In one embodiment, the apparatus further comprises a receiver that receives a report corresponding to the reporting configuration, wherein the report indicates one type of circular polarization or linear polarization.

In certain embodiments, the transmitter transmits downlink control information or medium access control signaling indicating for the user equipment to perform measurements on different polarizations on active bandwidth parts, inactive bandwidth parts, or a combination thereof.

In some embodiments, the transmitter transmits information that triggers a measurement and reporting procedure for polarization switching in active bandwidth parts, inactive bandwidth parts, or a combination thereof based on a location of the user equipment.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a user equipment-(UE), the method comprising:
receiving a configuration for a plurality of reference signals, wherein the configuration for each reference signal of the plurality of reference signals comprises a time-frequency resource, a time-domain behavior, a quasi-co-location assumption, a polarization type, and a usage type corresponding to a reference signal transmission, a reference signal reception, or a combination thereof; and
receiving a reporting configuration, wherein the reporting configuration corresponds to the plurality of reference signals, and the reporting configuration comprises the time-frequency resource, the time-domain behavior, and reporting quantities comprising polarization measurements for each reference signal of the plurality of reference signals.

2. The method of claim 1, wherein the plurality of reference signals is configured so that each reference signal of the plurality of reference signals corresponds to a polarization type.

3. The method of claim 1, wherein a quasi-co-location (QCL) type indicates an association between a polarization type corresponding to a source reference signal and a target reference signal.

4. The method of claim 1, further comprising transmitting a report corresponding to the reporting configuration, wherein the report for each reference signal of the plurality of reference signals indicates a polarization type based on polarization-based channel measurements.

5. The method of claim 1, further comprising transmitting a report corresponding to the reporting configuration, wherein the report indicates one type of circular polarization or linear polarization.

6. The method of claim 1, further comprising performing reference signal measurements on different bandwidth parts and polarizations that are configured to carry out bandwidth part and polarization switching.

7. The method of claim 1, further comprising receiving downlink control information (DCI) or medium access control MAC signaling indicating for the ULE to perform measurements on different polarizations on active bandwidth parts, inactive bandwidth parts, or a combination thereof.

8. The method of claim 1, further comprising receiving information that triggers a measurement and reporting procedure for polarization switching in active bandwidth parts, inactive bandwidth parts, or a combination thereof based on a location of the UE.

9. The method of claim 1, further comprising dynamically adjusting a polarization measurement and reporting periodicity based on a signal strength and a mapping table.

10. The method of claim 1, further comprising dynamically adjusting a polarization measurement and reporting periodicity based on a location of the UE and a mapping table.

11. The method of claim 1, further comprising configuring uplink resources to transmit multiple sounding reference signals (SRSs), wherein each SRS of the multiple SRSs is associated with a polarization type.

12. The method of claim 1, further comprising configuring uplink resources using spatial relation configuration, wherein this configuration also includes an indication of the polarization type of a source reference signal.

13. An apparatus comprising:
a processor; and
a memory coupled to the processor, the memory comprising instructions executable by the processor to cause the apparatus to:
receive a configuration for a plurality of reference signals, wherein the configuration for each reference signal of the plurality of reference signals comprises a time-frequency resource, a time-domain behavior, a quasi-co-location assumption, a polarization type, and a usage type corresponding to a reference signal transmission, a reference signal reception, or a combination thereof, and
receive a reporting configuration, wherein the reporting configuration corresponds to the plurality of reference signals, and the reporting configuration comprises the time-frequency resource, the time-domain behavior, and reporting quantities comprising polarization measurements for each reference signal of the plurality of reference signals.

14. An apparatus comprising:
a processor; and
a memory coupled to the processor, the memory comprising instructions executable by the processor to cause the apparatus to:
transmit a configuration for a plurality of reference signals, wherein the configuration for each reference signal of the plurality of reference signals comprises a time-frequency resource, a time-domain behavior, a quasi-co-location assumption, a polarization type, and a usage type corresponding to a reference signal transmission, a reference signal reception, or a combination thereof, and
transmit a reporting configuration, wherein the reporting configuration corresponds to the plurality of reference signals, and the reporting configuration comprises the time-frequency resource, the time-domain behavior, and reporting quantities comprising polarization measurements for each reference signal of the plurality of reference signals.

15. The apparatus of claim 14, wherein the plurality of reference signals is configured so that each reference signal of the plurality of reference signals corresponds to a polarization type.

16. The apparatus of claim 13, wherein the plurality of reference signals is configured so that each reference signal of the plurality of reference signals corresponds to a polarization type.

17. The apparatus of claim 13, wherein a quasi-co-location (QCL) type indicates an association between a polarization type corresponding to a source reference signal and a target reference signal.

18. The apparatus of claim 13, wherein the instructions are further executable by the processor to cause the apparatus to transmit a report corresponding to the reporting configuration, wherein the report for each reference signal of the plurality of reference signals indicates a polarization type based on polarization-based channel measurements.

19. The apparatus of claim 13, wherein the instructions are further executable by the processor to cause the apparatus to transmit a report corresponding to the reporting configuration, and the report indicates one type of circular polarization or linear polarization.

20. The apparatus of claim 13, wherein the instructions are further executable by the processor to cause the apparatus to perform reference signal measurements on different bandwidth parts and polarizations that are configured to carry out bandwidth part and polarization switching.
